(19) United States
(12) Patent Application Publication
(10) Pub. No.: US 2026/0203967 A1
(43) Pub. Date: Jul. 16, 2026

(54) METHOD, APPARATUS, DEVICE, AND MEDIUM FOR CONVERTING VIDEO DATA

(71) Applicant: Beijing Zitiao Network Technology Co., Ltd., Beijing (CN)

(72) Inventors: Shuo Sun, Beijing (CN); Meng Li, Beijing (CN)

(21) Appl. No.: 19/452,079

(22) Filed: Jan. 16, 2026

(30) Foreign Application Priority Data
Jan. 16, 2025 (WO) PCT/CN2025/072850

(51) Int. Cl. G06T 11/10; G06T 7/90

(52) U.S. Cl. CPC G06T 11/10; G06T 7/90

(57) ABSTRACT

A method, an apparatus, a device, and a medium for converting video data are provided. In a method, a color space of an original video is set to a default value in response to determining that the color space of the original video is null. A first color value of the first pixel is determined, for a first pixel in a first frame of a plurality of frames in the original video, in response to determining that a color range of the original video is null. The color range of the original video is determined based on the first color value. The original video is converted into a target video based on the color space and the color range.

### CROSS-REFERENCE TO RELATED APPLICATIONS

The present application claims priority to Internation Patent Application PCT/CN2025/072850, filed on January 16, 2025, and entitled “METHOD, APPARATUS, DEVICE, AND MEDIUM FOR CONVERTING VIDEO DATA”, the entirety of which is incorporated herein by reference.

### FIELD

Implementations of the present disclosure generally relate to video data conversion, and more particularly to a method, an apparatus, a device, and a computer-readable storage medium for converting video data based on color information.

### BACKGROUND

Currently, various video playing applications have been provided, and these applications can play videos in different formats. Videos may involve different color information (for example, color space and color range), and during the process of video encoding and/or decoding, corresponding color information needs to be used to perform the operation. If the wrong color information is used in the video encoding and/or decoding process, the color of the displayed video may be inconsistent with the color of the original video. At this point, it is desirable to determine the color information of the video in a more efficient manner and to perform video conversion based on the color information.

### SUMMARY

In a first aspect of the present disclosure, a method for converting video data is provided. In the method, a color space of an original video is set to a default value in response to determining that the color space of the original video is null. A first color value of the first pixel is determined for a first pixel in a first frame of a plurality of frames in the original video in response to determining that a color range of the original video is null. The color range of the original video is determined based on the first color value. The original video is converted into a target video based on the color space and the color range.

In a second aspect of the present disclosure, an apparatus for converting video data is provided. The apparatus comprises a setting module configured to set a color space of an original video to a default value in response to determining that the color space of the original video is null; a value determining module configured to determine, for a first pixel in a first frame of a plurality of frames in the original video, a first color value of the first pixel in response to determining that a color range of the original video is null; a range determining module configured to determine the color range of the original video based on the first color value; and a converting module configured to convert the original video into a target video based on the color space and the color range.

In a third aspect of the present disclosure, an electronic device is provided. The electronic device comprises at least one processor; and at least one memory coupled to the at least one processor and storing instructions for execution by the at least one processor, the instructions, when executed by the at least one processor, causing the electronic device to perform the method according to the first aspect of the present disclosure.

In a fourth aspect of the present disclosure, there is provided a computer-readable storage medium having stored thereon a computer program which, when executed by a processor, causes the processor to perform the method according to the first aspect of the present disclosure.

In a fifth aspect of the present disclosure, there is provided a computer program product, comprising a computer program, where the computer program, when executed by a processor, performs the method according to the first aspect of the present disclosure.

It should be understood that the content described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in combination with the accompanying drawings. In the drawings, the same or similar reference numbers refer to the same or similar elements, wherein:

FIG. 1A shows a block diagram of a process of video processing according to one implementation of the present disclosure;

FIG. 1B shows a block diagram of a color space according to one implementation of the present disclosure;

FIG. 2 shows a block diagram of a process for converting video data according to some implementations of the present disclosure;

FIG. 3 shows a block diagram of a process for converting video data according to some implementations of the present disclosure;

FIG. 4 shows a flowchart of a method for determining color information of video data according to some implementations of the present disclosure;

FIG. 5 shows a block diagram of a process of video live streaming according to some implementations of the present disclosure;

FIG. 6 shows a flowchart of a method for converting video data according to some implementations of the present disclosure;

FIG. 7 shows a block diagram of an apparatus for converting video data according to some implementations of the present disclosure; and

FIG. 8 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include/comprise” and similar terms should be understood to include “including/comprising but not limited to”. The term “based on” should be understood as “based at least in part on”. The terms “one implementation”, “an implementation”, or “the implementation” should be understood as “at least one implementation”. The term “some implementations” should be understood as “at least some implementations”. Other explicit and implicit definitions may also be included below. As used herein, the term “model” may represent an association between various data. For example, the association may be obtained based on various technical solutions currently known and/or to be developed in the future.

It may be understood that the data involved in the technical solution (including but not limited to the data itself, the acquisition or use of the data) should follow the requirements of the corresponding laws, regulations and related provisions.

It can be understood that, before the technical solutions disclosed in the embodiments of the present disclosure are used, the types of personal information related to the present disclosure, the usage scope, the usage scenario, and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to acquire and use the personal information of the user. Therefore, the user may autonomously select whether to provide personal information to software or hardware executing the operation of the technical solution of the present disclosure according to the prompt information.

As an optional but non-limiting implementation, in response to receiving an active request from the user, a manner of sending prompt information to the user may be, for example, a pop-up window, and prompt information may be presented in a text manner in the pop-up window. In addition, the pop-up window may further carry a selection control for the user to select “agree” or “disagree” to provide personal information to the electronic device.

It may be understood that the foregoing notification and obtaining a user authorization process is merely illustrative and does not constitute a limitation on implementations of the present disclosure, and other manners of meeting related laws and regulations may also be applied to implementations of the present disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed after a period of time elapses after an event occurs or a condition holds.

### Example Environment

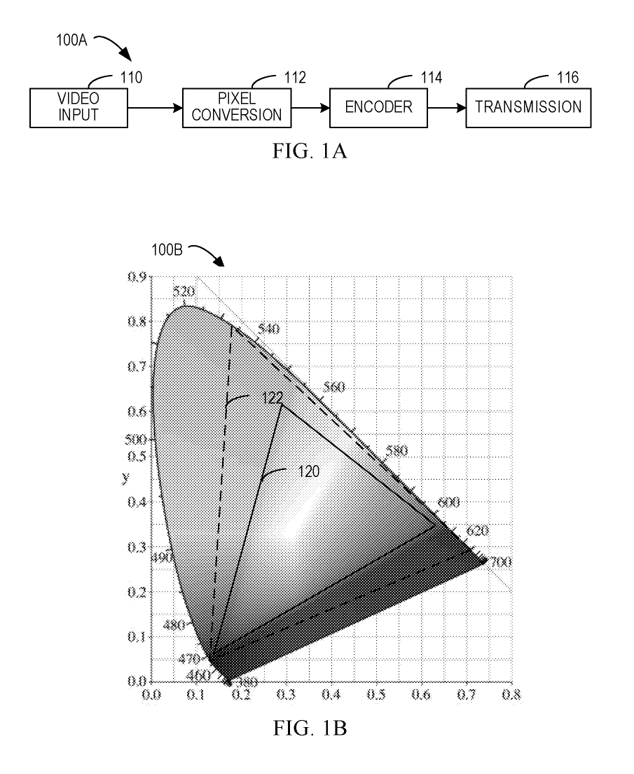

Currently, various video playing applications have been provided, and these applications may play videos in different formats. Videos may involve different color information (for example, color space and color range), and during the process of video encoding and/or decoding, corresponding color information needs to be used to perform the operation. FIG. 1A shows a block diagram 1A of a process of video processing according to one implementation of the present disclosure. As shown in FIG. 1, during the process of video processing, a video input 110 may be received. The video input 110 may be a video captured in real time or a stored video. For ease of description, a process of video conversion is described in a video live streaming environment. At this point, the video input 110 may be received from a capturing device (for example, a camera); alternatively, and/or in addition, screen-recorded data may be received from the computing device. Here, the input video is typically represented in an RGB format, which includes three color channels of red, green, and blue, and may form video data that is visible to human eyes. Generally, in order to save transmission bandwidth, the capturing device usually stores the original data in a JPEG format or a YUV format.

A pixel conversion 112 may be performed on the video in order to convert the input video data format to a specified format by an encoder 114. For example, videos in different formats may be converted into storage formats such as NV12 or V210. The encoder is an underlying algorithm module, which is used for compressing time domain redundancy, space domain redundancy, and coding redundancy information in the video data, thereby converting a larger original video to a smaller target video suitable for online storage and transmission. In turn, the target video may be transmitted 116 in a specified manner. For example, the target video compressed by the encoder may be stored locally, uploaded to the cloud, or live-streamed.

In the above process, it is necessary to determine the color information of the original video, and the color information may include a color space and a color range. Due to hardware limitations of display devices such as screens, color ranges displayed by display devices are different. Various criteria for the color space have been proposed in order to achieve consistent display specifications. Referring to FIG. 1B, a definition of the color space according to some implementations of the present disclosure is described, and FIG. 1B shows a block diagram 100B of the color space according to one implementation of the present disclosure. As shown, a region 120 represents an ultra high definition television (uHDTV) color space, and the uHDTV is mainly used for professional capturing devices, such as professional cameras, and the like. A region 122 represents a color space of a high definition television (HDTV), and the HDTV is mainly used for non-professional capturing devices, such as household cameras, intelligent terminal devices, and the like.

The above two color spaces specify the display color range of the display device, and if the capturing device does not use the RGB format but uses the JPEG or YUV data format, an appropriate color space parameter needs to be used to perform the conversion when display, otherwise the displayed color of the pixel may be different from the color of the pixel captured at the capturing device. The color information may further include the color range, for example, a full range and a limited range.

Generally, if the original video does not carry color information, a predetermined value may be used. However, the predetermined value may be inconsistent with the color information of the captured original video, thereby causing issues such as color deviation or loss of contrast in video stream data uploaded by a user appearing on the audience side. That is, the wrong color information may cause the color of the displayed video to be inconsistent with the color of the original video. At this point, it is desirable to determine the color information of the video in a more efficient manner and to perform video conversion based on the color information.

### Summary of Video Conversion

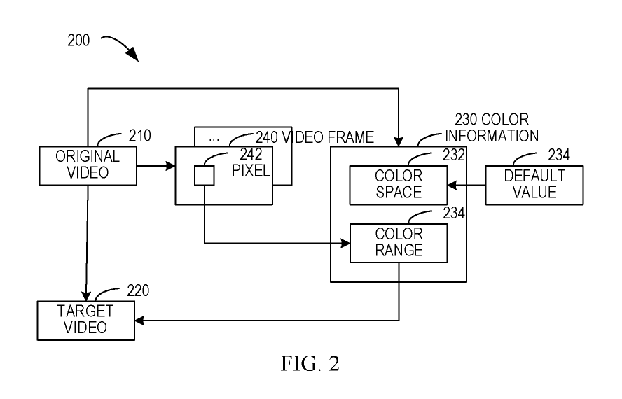

In order to at least partially solve the deficiencies in the prior art, a method for converting video data is proposed according to an implementation of the present disclosure. Referring to FIG. 2, a summary is described according to an implementation of the present disclosure, which shows a block diagram 200 for converting video data according to some implementations of the present disclosure. As shown in FIG. 2, an original video 210 may be received. Generally, the original video 210 may include color information 230 (for example, written by a capturing device), however, sometimes the color information 230 may be null, at which point the color of respective pixels in the original video 210 needs to be analyzed in order to determine the color information 230.

The color information 230 may comprise a color space 232 and a color range 234. A color space of an original video may be set to a default value 234 in response to determining that the color space 232 of the original video 210 is null. It should be understood that because the professional capturing device is a precision device, the professional capturing device may automatically set the color space and the color range for the captured original video, and at this time, there is no missing color information. Typically, the situation of missing color information only occurs in the original video captured by a non-professional capturing device, therefore the default value 234 may be set to HDTV.

The color range of the original video may be further determined. A first color value of the first pixel is determined, for a first pixel (for example, a pixel 242) in a first frame (for example, a video frame 240) of a plurality of frames in the original video, in response to determining that the color range 234 of the original video is null. The color range of the original video is determined based on the first color value. Specifically, one or more pixels in one or more video frames of the original video may be determined, and a corresponding color range is determined based on a color value of the pixel. For example, a portion of the pixels of the original video may be selected, or all pixels may be traversed to determine the color range. The original video may be converted into a target video based on the color space and the color range.

With the implementation of the present disclosure, in the case where the original video does not include the color information or the missing part of the color information, the color information may be determined in a simple and effective manner, and then the original video is converted into the target video according to the correct color information. In this way, it can be ensured that colors of respective pixels of the target video are consistent with colors of respective pixels of the original video.

### Detailed Procedure for Video Conversion

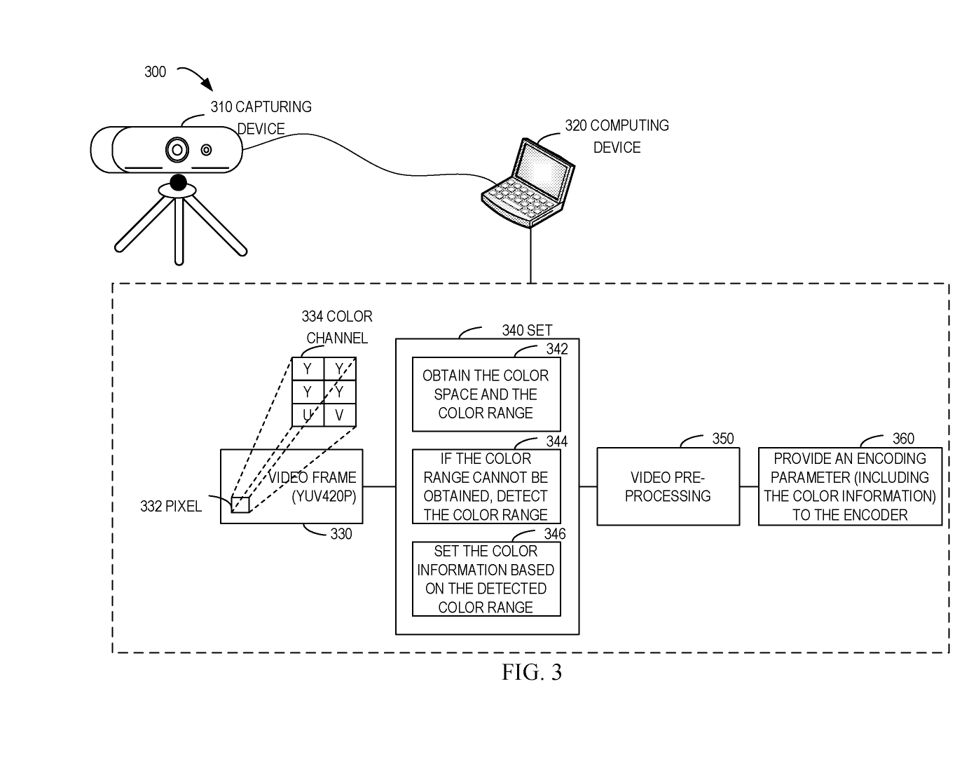

Having described a summary according to some implementations of the present disclosure, more details regarding a method for converting video data will be described below. For ease of description, a specific process for converting video data is described in a live streaming environment. FIG. 3 shows a block diagram 300 of a process for converting video data in accordance with some implementations of the present disclosure. As shown in FIG. 3, a live streaming application may be deployed at a computing device 320, and a capturing device 310 may capture the original video and send the original video to the computing device 320. It should be understood that although FIG. 3 illustrates capturing the original video by the separate capturing device 310, the computing device 320 may alternatively, and/or in addition include a built-in capturing device. In this case, the computing device 320 may directly obtain the original video. According to some implementations of the present disclosure, the method of the present disclosure may be implemented in a live streaming application.

Respective video frames, for example, a video frame 330, of the original video may be extracted. The color information of the original video may be set 340 based on at least a portion of the pixels (for example, a pixel 332) of the video frame 330. Specifically, at block 342, the color range of the original video may be obtained. At block 344, if it is determined that the color range cannot be obtained, the color range may be detected from respective video frames. At block 346, the color information may be set based on the detected color range, and the color space in the color information may be set to a default value. Further, preprocessing of the video may be performed at block 350, and at block 360, a respective encoding parameter is provided to the encoder.

The format of the original video may be recognized, and if the format is a YUV format (for example, NV12, YV12, and the like), it may be determined whether the original video carries the color information (including the color space and the color range). If complete color information may be obtained, the obtained color information may be used to convert the original video to the target video. Specifically, the original video is processed based on the color space and the color range in response to determining that the video data includes the color space and the color range, to generate the target video.

Alternatively, and/or in addition, if the color space and/or the color range cannot be obtained, the color space and/or the color range may be set according to the original video. Specifically, if the color space is null (that is, the original video does not carry related information about the color space), the color space may be set to the default value HDTV. Generally, the color space of non-professional capturing devices is HDTV and the color space may be lost, so that the color space of the original video may be accurately determined.

According to some implementations of the present disclosure, if the color range is null (that is, the original video does not carry related information about the color range), the color range of the original video may be determined based on the colors of the respective pixels of the original video. For ease of description, the process of determining the color range is described below by using the YUV format as an example. As shown in FIG. 3, the pixel 332 may include 3 color channels: a Y channel, a U channel, and a V channel. In the context of the present disclosure, the color channel may be referred to as a channel for short.

Firstly, the YUV format is introduced, and in the process of converting an analog signal into a digital signal, a sampling technology may be involved. For a normal 8-bit image, each channel in the YUV is represented by an 8-bit binary number, that is, there are 256 grayscale levels. For example, for the Y channel, 255 represents white, and 0 represents black. At this point, there are 256 levels (that is, 0-255) which are referred to as the full range. In the 8-bit YUV format, the value range of the Y channel is limited to 16-235, and the value range of the U and V channels is 16-240. Such value representation method for color is generally referred to as the limited range. The grayscale levels of the pixels corresponding to different color ranges are different, and once the wrong color range is used in the conversion, a grayscale loss (the conversion of the limited range is used for the original video captured according to the full range) or the color darkening (the conversion of the full range is used for the original video captured according to the limited range) may occur.

According to some implementations of the present disclosure, a pixel (for example, referred to as a first pixel) may be determined from a video frame of the original video. The first color value of the first pixel may comprise a plurality of first channel values respectively corresponding to a plurality of color channels. Further, in the process of determining the color range of the original video based on the first color value, the color range of the original video may be determined based on the plurality of first channel values. With some implementations of the present disclosure, the color range of the original video may be determined by analyzing the colors of respective channels for respective pixels in the original video, thereby determining the color range in a more accurate manner.

In the context of the present disclosure, the color range of respective pixels in respective frames of the original video may be detected one by one, and then the color range of the original video is determined. According to some implementations of the present disclosure, each pixel of each video frame may be traversed, and the value of each channel for each pixel is determined. For example, if it is determined that the value of each channel for each pixel of each video frame meets the limited range, it may be determined that the color range of the original video is the limited range. Alternatively, and/or in addition, a portion of the pixels in a portion of the video frames may be processed. When processing any channel for any pixel in any video frame, assuming that the value of the channel does not conform to the limited range, it may be determined that the color range of the original video is the full range. In this case, the cyclic traversal process may be broken out of, thereby reducing computational resource overhead and time resource overhead of the processing process.

Specifically, each video frame in the original video may be extracted one by one, and a portion of video frames in the original video may be extracted according to a predetermined interval (for example, according to 2 frames, 3 frames, or other intervals). Further, each pixel in the video frame may be extracted one by one, and a portion of pixels in the video frame may be extracted in a predetermined manner. For example, a region of interest (for example, a region located at the center portion of the video frame, the brightest region, the darkest region, or a region with a relatively prominent color, and so on) in the video frame may be specified. Further, more video frames may be obtained in the region of interest, and fewer video frames may be obtained in other regions. In this way, the number of pixels to be processed may be reduced, and the efficiency of the video processing process may be improved.

According to some implementations of the present disclosure, in the process of determining the color range of the original video based on the plurality of first channel values, the color range of the original video is set to the full range for a first channel of the plurality of color channels in response to determining that a first channel value corresponding to the first channel is outside a first channel value range, and the first channel value range corresponds to the first channel. It should be understood that respective channels have a channel value range for the channel, and if the channel value is outside a corresponding channel value range, the color range may be directly determined as the full range.

According to some implementations of the present disclosure, the first channel is a Y channel, and the first channel value range is [16, 235]. In this case, the first channel value is the value of the Y channel, and if the value is outside [16, 235], the color range of the original video may be directly determined as the full range. With some implementations of the present disclosure, there is no need for the values of other channels (for example, U, V channels) to be extracted, the color range can be determined based only on the value of the Y channel.

According to some implementations of the present disclosure, the first channel may include any of the U channel and the V channel, and the first channel value range is [16, 240]. For example, the first channel value may be a value of the U channel, and if the value is outside [16, 240], the color range of the original video may be directly determined to be the full range. With some implementations of the present disclosure, there is no need for the value of other channels (for example, Y, V channels) to be extracted, and the color range may be determined based only on the value of the U channel. For another example, the first channel value may be a value of the V channel, and if the value is outside [16, 240], the color range of the original video may be directly determined to be the full range. With some implementations of the present disclosure, there is no need for the values of other channels (for example, Y, U channels) to be extracted, and the color range may be determined based only on the values of the V channel.

According to some implementations of the present disclosure, as long as the value of any channel exceeds a corresponding color range, the color range of the original video may be set to the full range. Alternatively, and/or in addition, only the values of all channels are within the corresponding color range, the color range of the original video can be determined as the limited range. Specifically, a second channel value of a second channel for the first pixel is determined in response to determining that the first channel value of the first channel is within the first channel value range. Here, the second channel comprises a channel other than the first channel. The color range of the original video is set to the limited range in response to determining that the second channel value is within a second channel value range, and the second channel value range corresponds to the second channel.

For example, if it is determined that the value of the Y channel satisfies [16, 235], it may be determined whether both the U channel and the V channel satisfy [16, 240]. If it is determined that both the U channel and the V channel satisfy [16, 240], then it may be determined that the color range is the limited range. For another example, if it is determined that the value of the U channel satisfies [16, 240], it may be determined whether the Y channel satisfies [16, 235] and whether the V channel satisfies [16, 240]. If it is determined that the Y channel satisfies [16, 235] and it is determined that the V channel satisfies [16, 240], then it may be determined that the color range is the limited range. For another example, if it is determined that the value of the V channel satisfies [16, 240], it may be determined whether the Y channel satisfies [16, 235] and whether the U channel satisfies [16, 240]. If it is determined that the Y channel satisfies [16, 235] and it is determined that the U channel satisfies [16, 240], then it may be determined that the color range is the limited range. With some implementations of the present disclosure, the color range may be determined in a simpler and more accurate manner.

According to some implementations of the present disclosure, the color distribution of respective pixels in respective video frames of the original video may be different, and respective pixels in a video frame meet the limited range, which does not indicate that all pixels in all video frames of the original video meet the limited range. If it is determined that the color range is the limited range, the process described above is to be performed for the subsequent video frame in order to determine whether there is a pixel that does not satisfy the limited range. If there is a pixel that does not satisfy the limited range, the color range of the original video may be updated to the full range. With some implementations of the present disclosure, the color range may be updated as more video frames are received, so that the determined color range can be correctly matched to the original video.

According to some implementations of the present disclosure, a third channel value of a first channel for a second pixel in a second frame of the plurality of frames in the original video is determined in response to determining that the color range of the original video is the limited range. Further, the color range of the original video is updated to the full range in response to determining that the third channel value is outside the first channel value range. The first channel may comprise any of the Y channel, the U channel, and the V channel. As long as the value of any channel exceeds the corresponding value range, it can be determined that the color range of the original video is the full range. Here, the second frame may be determined in various manners, the subsequent frame immediately adjacent to the first frame may be determined as the second frame, alternatively, and/or in addition, the second frame may be selected according to a predetermined condition, for example, the second frame may be selected according to a predetermined condition (for example, at a 2 frame, 3 frame, or another interval), and the interval between the second frame and the first frame satisfies the predetermined condition. In this way, there is no need for each video frame to be analyzed one by one, thereby reducing computational resource overhead and time overhead in video processing.

According to some implementations of the present disclosure, a fourth channel value of the second channel for the second pixel may be further determined, and the second channel may be any channel different from the first channel. The color range of the original video is updated to the full range in response to determining that the fourth channel value is outside the second channel value range. Specifically, the second pixel in the second frame may be processed in a similar manner as the first pixel in the first frame. With some implementations of the present disclosure, the color range of the original video may be determined based on the value of the respective channels one by one.

According to some implementations of the present disclosure, the original video may be processed based on the determined color space and color range to generate the target video. It should be understood that the color space and the color range herein may be a color space and a color range extracted from the original video, or may be a color space and a color range determined based on the method described above. With some implementations of the present disclosure, a more accurate color space and color range may be determined, so that the color of the subsequently displayed target video is consistent with the color of the original video captured by the capturing device.

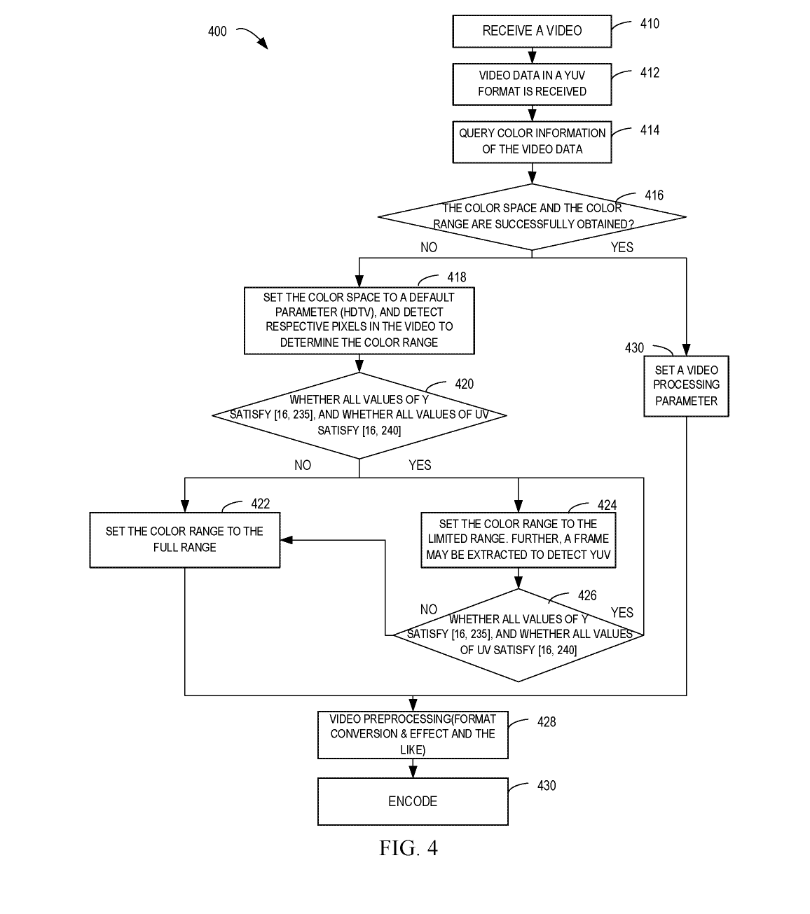

Having described various steps of processing video data, hereinafter, referring to FIG. 4, a complete flow of determining color information is described, which shows a flowchart of a method 400 for determining color information of video data in accordance with some implementations of the present disclosure. As shown in FIG. 4, at block 410, a video to be processed may be received, for example, the computing device may receive the video from an independent capturing device or a built-in capturing device. At block 412, video data in a YUV format may be received. If the received video data involves other formats, the received video data may be converted to the YUV format based on a format conversion process. At block 414, color information of the video data may be queried. For example, whether the video data carries the color information may be queried via an application programming interface matching the video format. Here, the color information may comprise the color space and the color range.

At block 416, if the color space and the color range may be successfully obtained, it indicates that the color information is complete at this point, and the method 400 may proceed to block 430 to set a video processing parameter based on the obtained color space and color information. At block 416, if it is determined that the color space and the color range are not successfully obtained, the method 400 proceeds to block 418. At block 418, if the color space is not successfully obtained, the color space may be set to a default parameter (for example, HDTV). Further, if the color range is not successfully obtained, the range of the respective pixels in the video may be detected according to the method described above, thereby determining the specific type of the color range.

Specifically, a portion of video frames in the video may be selected, or all video frames in the video may be traversed. Further, a portion of pixels in a certain video frame may be selected, or all pixels in the video frame may be traversed. For a certain pixel, it may be determined, at block 420, whether the values of the Y, U, and V channels for the respective pixels satisfy a corresponding value range respectively. Specifically, if it is determined that all values of the Y channel satisfy [16, 235], and all values of the U channel and the V channel satisfy [16, 235], the method 400 proceeds to block 424 and the color range may be set to the limited range. Alternatively, and/or in addition, in order to improve accuracy, the value of the YUV channel of the subsequent other video frame may be detected, to update the color range to the full range, if it is found that there is a pixel not satisfying the value range.

At block 426, it may be determined whether all values of the Y channel satisfy [16, 235], and whether all values of the U channel and the V channel satisfy [16, 235]. If the determination is “NO”, the method 400 proceeds to block 422 to set the color range to the full range. Then, at block 428, preprocessing may be performed for the video in accordance with the determined color space and color range. The preprocessing may include, but is not limited to, format conversion processing, effect processing, and the like. Specifically, the video may be converted into a desired format, or effects such as text, stickers, style conversion, and the like may be added to the video. At block 430, an encoding processing may be performed for the preprocessed video, thereby generating an encoded video in a compressed format. If the determination at block 426 is “YES”, the method 400 returns to block 424. At this point, the color range continues to maintain the limited range, and the respective pixels in the subsequent video frame may continue to be examined in a similar manner.

It should be understood that although the process of determining the color range is described above in the YUV format as an example, alternatively, and/or in addition, the pixels may be represented in an RGB format, and the corresponding YUV format may be determined based on a conversion equation between the RGB format and the YUV format, and then the color range is determined according to the process described above.

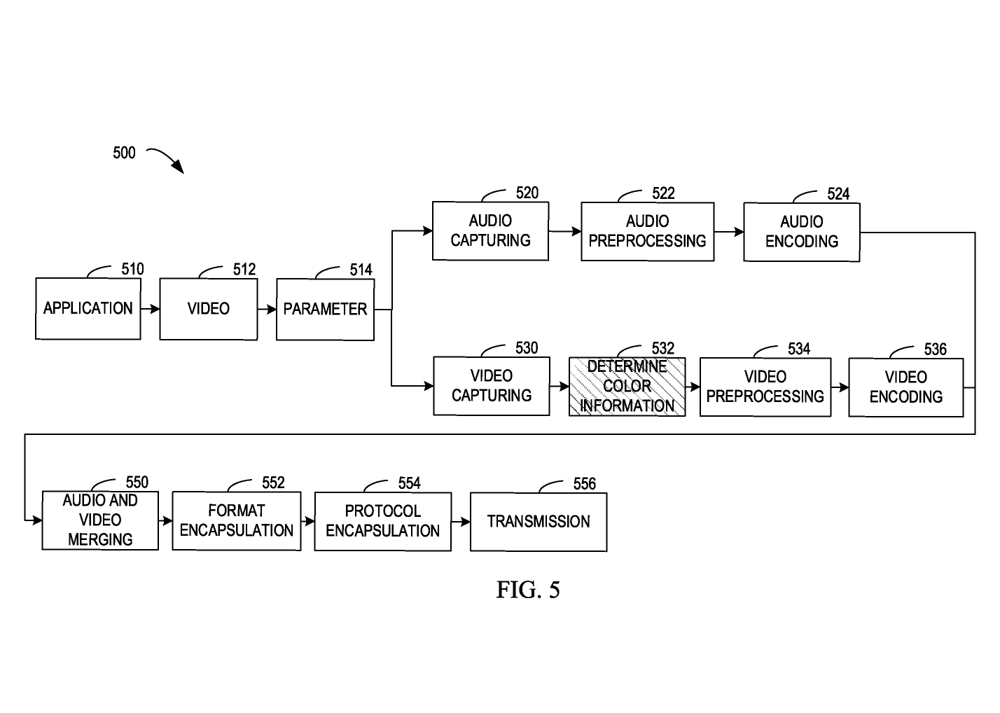

According to some implementations of the present disclosure, the foregoing technical solutions may be performed in an environment of a live streaming video. More details are described with reference to FIG. 5, which illustrates a block diagram 500 of a process of video live streaming in accordance with some implementations of the present disclosure. As shown in FIG. 5, a video 512 may be obtained by an application 510 that provides a video live streaming function, and a specific parameter 514 of an encoder may be further configured. It should be understood that the captured data may involve audio data and video data, and two types of data may be processed in an audio processing branch and a video processing branch, respectively.

In the audio branch, audio data may be captured at block 520, audio preprocessing may be performed at block 522, and audio encoding may be performed at block 524. In the video processing branch, video data may be captured at block 530. The method described above may be performed at block 532 in order to determine the color information of the captured video data. Preprocessing may be performed for video data at block 534, and video encoding may be performed at block 536. At block 550, output data from the audio processing branch and the video processing branch may be merged to generate a live streaming data stream including an audio portion and a video portion. At blocks 552 and 554, the generated data stream may be encapsulated in a predetermined format and protocol to transmit the live data stream to other devices at block 556.

In the context of the present disclosure, if the color range of the image captured by the video cannot be obtained, the color range may be adaptively detected based on the process described above. In this way, it is possible for a video consistent with the color of the originally captured video to be presented. Further, in the above process, on-demand or live streaming is not limited, while the color information may be determined in all video-playing scenarios by using the manner described above. Further, in the above process, no manual operation by the video creator and/or the live streamer is required, while the color information may be adaptively determined.

With the implementation of the present disclosure, in the case where the original video does not include the color information or the missing part of the color information, the color information may be determined in a simple and effective manner, and then the original video is converted into the target video according to the correct color information. In this way, it can be ensured that colors of respective pixels of the target video are consistent with colors of respective pixels of the original video.

### Example Process

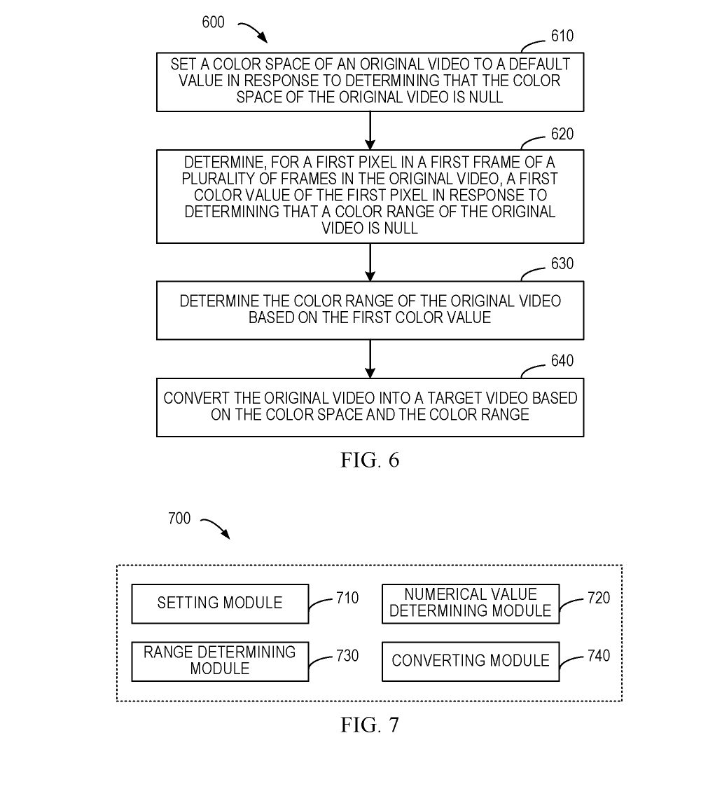

FIG. 6 shows a flowchart 600 of a method 600 for converting video data according to some implementations of the present disclosure. At block 610, a color space of an original video is set to a default value in response to determining that the color space of the original video is null. At block 620, a first color value of the first pixel is determined, for a first pixel in a first frame of a plurality of frames in the original video, in response to determining that a color range of the original video is null. At block 630, the color range of the original video is determined based on the first color value. At block 640, the original video is converted into a target video based on the color space and the color range.

According to some implementations of the present disclosure, the first color value comprises a plurality of first channel values respectively corresponding to a plurality of color channels, and determining the color range of the original video based on the first value comprises: determining the color range of the original video based on the plurality of first channel values.

According to some implementations of the present disclosure, determining the color range of the original video based on the plurality of first channel values comprises: setting the color range of the original video to a full range, for a first channel of the plurality of color channels, in response to determining that a first channel value corresponding to the first channel is outside a first channel value range, the first channel value range corresponding to the first channel.

According to some implementations of the present disclosure, determining the color range of the original video further comprises: determining a second channel value of a second channel for the first pixel in response to determining that the first channel value of the first channel is within the first channel value range, the second channel comprising any channel different from the first channel; and setting the color range of the original video to a limited range in response to determining that the second channel value is within a second channel value range, the second channel value range corresponding to the second channel.

According to some implementations of the present disclosure, determining the color range of the original video further comprises: determining a third channel value of a first channel for a second pixel in a second frame of the plurality of frames in the original video in response to determining that the color range of the original video is the limited range; and updating the color range of the original video to the full range in response to determining that the third channel value is outside the first channel value range.

According to some implementations of the present disclosure, determining the color range of the original video further comprises: determining a fourth channel value of a second channel for the second pixel; and updating the color range of the original video to the full range in response to determining that the fourth channel value is outside the second channel value range.

According to some implementations of the present disclosure, an interval between the second frame and the first frame satisfies a predetermined condition.

According to some implementations of the present disclosure, the first channel is a Y channel and the first channel value range is [16, 235].

According to some implementations of the present disclosure, the first channel comprises any of a U channel and a V channel, and the first channel value range is [16, 240].

According to some implementations of the present disclosure, the original video comprises a live streaming video and the method is implemented in an application for providing live streaming service.

### Example Apparatus and Device

FIG. 7 shows a block diagram of an apparatus 700 for converting video data according to some implementations of the present disclosure. The apparatus comprises: a setting module 710 configured to set a color space of an original video to a default value in response to determining that the color space of the original video is null; a value determining module 720 configured to determine, for a first pixel in a first frame of a plurality of frames in the original video, a first color value of the first pixel in response to determining that a color range of the original video is null; a range determining module 730 configured to determine the color range of the original video based on the first color value; and a converting module 740 configured to convert the original video into a target video based on the color space and the color range.

According to some implementations of the present disclosure, the first color value comprises a plurality of first channel values respectively corresponding to a plurality of color channels, and the range determining module is further configured to determine the color range of the original video based on the plurality of first channel values.

According to some implementations of the present disclosure, the range determining module is further configured to set the color range of the original video to a full range, for a first channel of the plurality of color channels, in response to determining that a first channel value corresponding to the first channel is outside a first channel value range, the first channel value range corresponding to the first channel.

According to some implementations of the present disclosure, the range determining module is further configured to determine a second channel value of a second channel for the first pixel in response to determining that the first channel value of the first channel is within the first channel value range, the second channel comprising any channel different from the first channel; and set the color range of the original video to a limited range in response to determining that the second channel value is within a second channel value range, the second channel value range corresponding to the second channel.

According to some implementations of the present disclosure, the range determining module is further configured to determine a third channel value of a first channel for a second pixel in a second frame of the plurality of frames in the original video in response to determining that the color range of the original video is the limited range; and update the color range of the original video to the full range in response to determining that the third channel value is outside the first channel value range.

According to some implementations of the present disclosure, the range determining module is further configured to determine a fourth channel value of a second channel for the second pixel; and update the color range of the original video to the full range in response to determining that the fourth channel value is outside the second channel value range.

According to some implementations of the present disclosure, an interval between the second frame and the first frame satisfies a predetermined condition.

According to some implementations of the present disclosure, the first channel is a Y channel and the first channel value range is [16, 235].

According to some implementations of the present disclosure, the first channel comprises any of a U channel and a V channel, and the first channel value range is [16, 240].

According to some implementations of the present disclosure, the original video comprises a live streaming video and the method is implemented in an application for providing live streaming service.

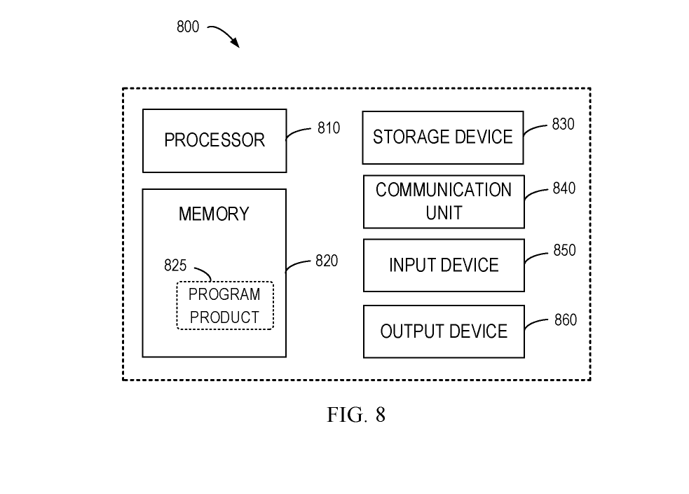

FIG. 8 illustrates a block diagram of a device 800 capable of implementing various implementations of the present disclosure. It should be understood that the computing device 800 shown in FIG. 8 is merely an example and should not constitute any limitation on the functionality and scope of the implementations described herein. The computing device 800 shown in FIG. 8 may be configured to implement the method described above.

As shown in FIG. 8, the computing device 800 is in the form of a general-purpose computing device. Components of the computing device 800 may include, but are not limited to, one or more processing units or processors 810, a memory 820, a storage device 830, one or more communication units 840, one or more input devices 850, and one or more output devices 860. The processor 810 may be an actual or virtual processor and capable of performing various processes according to programs stored in the memory 820. In multiprocessor systems, multiple processors execute computer-executable instructions in parallel to improve parallel processing capabilities of the computing device 800.

The computing device 800 typically includes a plurality of computer storage mediums. Such medium may be any available medium accessible by the computing device 800, including, but not limited to, volatile and non-volatile mediums, removable and non-removable mediums. The memory 820 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. A storage device 830 may be a removable or non-removable medium and may include a machine-readable medium, such as a flash drive, a magnetic disk, or any other medium, which may be capable of storing information and/or data (for example, training data for training) and may be accessed within the computing device 800.

The computing device 800 may further include an additional removable/non-removable, volatile/non-volatile storage medium. Although not shown in FIG. 8, a magnetic disk drive for reading from or writing to a removable, non-volatile magnetic disk (for example, a “floppy disk”) and an optical disk drive for reading from or writing to a removable, non-volatile optical disk may be provided. In these cases, each drive may be connected to a bus (not shown) by one or more data medium interfaces. The memory 820 may include a computer program product 825 having one or more program modules configured to perform various methods or actions of various implementations of the present disclosure.

The communications unit 840 implements communications with other computing devices over a communications medium. In addition, the functionality of components of the computing device 800 may be implemented in a single computing cluster or multiple computing machines capable of communicating over a communication connection. Thus, the computing device 800 may operate in a networked environment using logical connections with one or more other servers, network personal computers (PCs), or another network node.

The input device 850 may be one or more input devices such as a mouse, a keyboard, a trackball, or the like. The output device 860 may be one or more output devices, such as a display, a speaker, a printer, or the like. The computing device 800 may also communicate with one or more external devices (not shown) through the communication unit 840 as needed, an external device such as a storage device, a display device, and the like, communicates with one or more devices that enable a user to interact with the computing device 800, or communicates with any device (for example, a network card, a modem, and the like ) that enables the computing device 800 to communicate with one or more other computing devices. Such communication may be performed via an input/output (I/O) interface (not shown).

According to an implementation of the present disclosure, there is provided a computer-readable storage medium having computer-executable instructions stored thereon, where the computer-executable instructions are executed by a processor to perform the method described above. According to an implementation of the present disclosure, a computer program product is further provided, the computer program product is tangibly stored on a non-transitory computer-readable medium and includes computer-executable instructions, and the computer-executable instructions are executed by a processor to perform the method described above. According to an implementation of the present disclosure, a computer program product is provided, where a computer program is stored, and when the program is executed by a processor, the foregoing method is performed.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of respective blocks in the flowcharts and/or block diagrams, may be implemented by computer-readable program instructions.

These computer-readable program instructions may be provided to a processor of a general-purpose computer, a special-purpose computer, or other programmable data processing device to produce a machine, such that the instructions, when executed by the processor of a computer or other programmable data processing device, produce a device to implement the functions/acts specified in the flowchart and/or block diagram. These computer-readable program instructions may also be stored in a computer-readable storage medium that cause the computer, programmable data processing device, and/or other devices to function in a particular manner, such that the computer-readable medium storing instructions includes an article of manufacture including instructions to implement aspects of the functions/acts specified in one or more blocks in the flowchart and/or block diagram.

The computer-readable program instructions may be loaded onto a computer, other programmable data processing device, or other devices, on which a series of operational steps are performed to produce a computer-implemented process such that the instructions executed on the computer, other programmable data processing device, or other device implement the functions/acts specified in one or more blocks in the flowchart and/or block diagram.

The flowchart and block diagrams in the figures show the architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for converting video data, comprising:
setting a color space of an original video to a default value in response to determining that the color space of the original video is null;
determining, for a first pixel in a first frame of a plurality of frames in the original video, a first color value of the first pixel in response to determining that a color range of the original video is null;
determining the color range of the original video based on the first color value; and
converting the original video into a target video based on the color space and the color range.

2. The method of claim 1, wherein the first color value comprises a plurality of first channel values respectively corresponding to a plurality of color channels, and determining the color range of the original video based on the first value comprises: determining the color range of the original video based on the plurality of first channel values.

3. The method of claim 2, wherein determining the color range of the original video based on the plurality of first channel values comprises: setting the color range of the original video to a full range, for a first channel of the plurality of color channels, in response to determining that a first channel value corresponding to the first channel is outside a first channel value range, the first channel value range corresponding to the first channel.

4. The method of claim 3, wherein determining the color range of the original video further comprises:
determining a second channel value of a second channel for the first pixel in response to determining that the first channel value of the first channel is within the first channel value range, the second channel comprising any channel different from the first channel; and
setting the color range of the original video to a limited range in response to determining that the second channel value is within a second channel value range, the second channel value range corresponding to the second channel.

5. The method of claim 4, wherein determining the color range of the original video further comprises:
determining a third channel value of a first channel for a second pixel in a second frame of the plurality of frames in the original video in response to determining that the color range of the original video is the limited range; and
updating the color range of the original video to the full range in response to determining that the third channel value is outside the first channel value range.

6. The method of claim 5, wherein determining the color range of the original video further comprises:
determining a fourth channel value of a second channel for the second pixel; and
updating the color range of the original video to the full range in response to determining that the fourth channel value is outside the second channel value range.

7. The method of claim 5, wherein an interval between the second frame and the first frame satisfies a predetermined condition.

8. The method of claim 3, wherein the first channel is a Y channel and the first channel value range is [16, 235].

9. The method of claim 3, wherein the first channel comprises any of a U channel and a V channel, and the first channel value range is [16, 240].

10. The method of claim 1, wherein the original video comprises a live streaming video and the method is implemented in an application for providing live streaming service.

11. An electronic device, comprising:
at least one processor; and
at least one memory coupled to the at least one processor and storing instructions for execution by the at least one processor, the instructions, when executed by the at least one processor, causing the electronic device to perform acts comprising:
setting a color space of an original video to a default value in response to determining that the color space of the original video is null;
determining, for a first pixel in a first frame of a plurality of frames in the original video, a first color value of the first pixel in response to determining that a color range of the original video is null;
determining the color range of the original video based on the first color value; and
converting the original video into a target video based on the color space and the color range.

12. The electronic device of claim 11, wherein the first color value comprises a plurality of first channel values respectively corresponding to a plurality of color channels, and determining the color range of the original video based on the first value comprises: determining the color range of the original video based on the plurality of first channel values.

13. The electronic device of claim 12, wherein determining the color range of the original video based on the plurality of first channel values comprises: setting the color range of the original video to a full range, for a first channel of the plurality of color channels, in response to determining that a first channel value corresponding to the first channel is outside a first channel value range, the first channel value range corresponding to the first channel.

14. The electronic device of claim 13, wherein determining the color range of the original video further comprises:
determining a second channel value of a second channel for the first pixel in response to determining that the first channel value of the first channel is within the first channel value range, the second channel comprising any channel different from the first channel; and
setting the color range of the original video to a limited range in response to determining that the second channel value is within a second channel value range, the second channel value range corresponding to the second channel.

15. The electronic device of claim 14, wherein determining the color range of the original video further comprises:
determining a third channel value of a first channel for a second pixel in a second frame of the plurality of frames in the original video in response to determining that the color range of the original video is the limited range; and
updating the color range of the original video to the full range in response to determining that the third channel value is outside the first channel value range.

16. The electronic device of claim 15, wherein determining the color range of the original video further comprises:
determining a fourth channel value of a second channel for the second pixel; and
updating the color range of the original video to the full range in response to determining that the fourth channel value is outside the second channel value range.

17. The electronic device of claim 15, wherein an interval between the second frame and the first frame satisfies a predetermined condition.

18. The electronic device of claim 13, wherein the first channel is a Y channel and the first channel value range is [16, 235].

19. The electronic device of claim 13, wherein the first channel comprises any of a U channel and a V channel, and the first channel value range is [16, 240].

20. A non-transitory computer-readable storage medium having stored thereon computer instructions that, when executed by a processor, causing the processor to perform acts comprising:
setting a color space of an original video to a default value in response to determining that the color space of the original video is null;
determining, for a first pixel in a first frame of a plurality of frames in the original video, a first color value of the first pixel in response to determining that a color range of the original video is null;
determining the color range of the original video based on the first color value; and
converting the original video into a target video based on the color space and the color range..
